(19) United States
(12) Patent Application Publication
(10) Pub. No.: US 2013/0224969 A1
(43) Pub. Date: Aug. 29, 2013

(54) CHARGE INLET

(71) Applicant: Kabushiki Kaisha Tokai Rika Denki Seisakusho, (US)

(72) Inventors: Harehide SASAKI, Aichi (JP); Yoshiaki KATO, Aichi (JP)

(73) Assignee: KABUSHIKI KAISHA TOKAI RIKA DENKI SEISAKUSHO, Aichi (JP)

(21) Appl. No.: 13/758,219

(22) Filed: Feb. 4, 2013

(30) Foreign Application Priority Data
Feb. 28, 2012 (JP) 2012-042083

(51) Int. Cl. H01R 24/76

(52) U.S. Cl. CPC H01R 24/76
USPC 439/34

(57) ABSTRACT

A charge inlet connectable to a power supplying plug that charges a vehicle battery includes a power supplying plug fitting unit connected to the power supplying plug. A vehicle body connector fitting unit is arranged integrally with the power supplying plug fitting unit. The vehicle body connector fitting unit is connected to a vehicle body connector extending from the battery. The charge inlet includes a direct connection type connector that allows for direct connection of the vehicle body connector to the vehicle body connector fitting unit.

### CROSS-REFERENCE TO RELATED APPLICATIONS

This application is based upon and claims the benefit of priority from prior Japanese Patent Application No. 2012-042083, filed on Feb. 28, 2012, the entire contents of which are incorporated herein by reference.

### FIELD

The present invention relates to a charge inlet to which a power supplying plug is connected.

### BACKGROUND

Consumers have become conscious of environmental problems. As a result, vehicles that emit little carbon dioxide, for example, plug-in hybrid vehicles and electric vehicles, have become popular. Such a vehicle includes a battery charged by connecting a power supplying plug, which is arranged on a distal end of a charging cable extending from a charging facility, to a charge inlet, which is arranged in a vehicle, and turning on a power switch. Japanese Laid-Open Patent Publication No. 9-161898 describes an electric vehicle charging connector for such a charging system.

A charge inlet is electrically connected to a vehicle body connector arranged in a vehicle. Japanese Laid-Open Patent Publication No. 2010-166756 describes the use of a wire harness to connect a charge inlet to a vehicle body connector. The vehicle body connector is further connected by another wire harness to an in-vehicle electric device such as a battery.

In the structure described in Japanese Laid-Open Patent Publication No. 2010-166756, a wire harness is required between the charge inlet and vehicle body connector and between the vehicle body connector and in-vehicle electric device. This increases the number of wire harnesses used. As a result, the wire harnesses structure is complicated, and the task for connecting wire harnesses is burdensome. Further, the wire harnesses interfere with the coupling of the charge inlet to the vehicle body, and the task for coupling the charge inlet becomes difficult.

### SUMMARY

A first aspect of the present invention is a charge inlet connectable to a power supplying plug that charges a vehicle battery. The charge inlet includes a power supplying plug fitting unit connected to the power supplying plug. A vehicle body connector fitting unit is arranged integrally with the power supplying plug fitting unit and connected to a vehicle body connector extending from the battery. The charge inlet includes a direct connection type connector that allows for direct connection of the vehicle body connector to the vehicle body connector fitting unit.

A second aspect of the present invention is a charge inlet, the charge inlet including a power supplying plug fitting unit and a vehicle body connector fitting unit. The power supplying plug fitting unit is arranged on a first distal portion of the charge inlet and operative to engage a power supply plug and maintain an electrical connection with the power supply plug. The vehicle body connector fitting unit is arranged on a second distal portion of the charge inlet and including a mechanical engagement portion and an electrical terminal portion. The vehicle body connector fitting unit is operative to mechanically engage a connector of a wire harness and align the electrical terminal portion of the vehicle body connector fitting unit with a terminal of the wire harness that is electrically connected to an in-vehicle electric device.

Other aspects and advantages of the present invention will become apparent from the following description, taken in conjunction with the accompanying drawings, illustrating by way of example the principles of the invention

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic perspective view showing a charge inlet and power supplying plug according to one embodiment;

FIG. 2 is a perspective view showing a structure that connects a vehicle body connector fitting unit of a charge inlet to a vehicle body connector;

FIG. 3 is a perspective view showing a power supplying plug fitting unit of the charge inlet and the vehicle body connector fitting unit in a state separated from each other;

FIG. 4 is an exploded perspective view of the charge inlet;

FIG. 5 is a cross-sectional view taken along line II-II in FIG. 4;

FIG. 6 is a cross-sectional view showing a state in which the vehicle body connector fitting unit of FIG. 5 is connected to the vehicle body connector;

FIG. 7 is a horizontal cross-sectional view showing a seal for a terminal; and

FIG. 8 is a vertical cross-sectional view showing a seal for a terminal.

### DESCRIPTION OF THE EMBODIMENTS

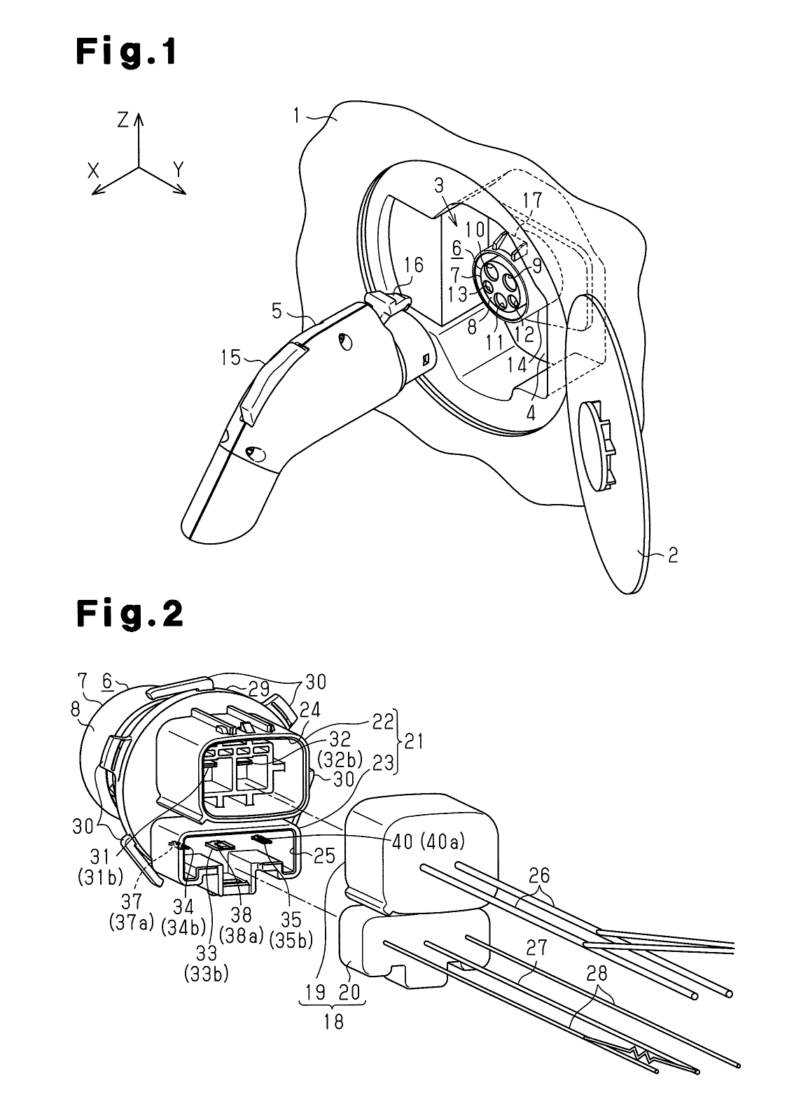

One embodiment of a charge inlet will now be described with reference to FIGS. 1 to 8.

Referring to FIG. 1, a vehicle (e.g., plug-in hybrid vehicle and electrical vehicle) includes a vehicle body 1 provided with a power supplying port 3. A lid 2 opens and closes the power supplying port 3. The power supplying port 3 includes a panel 4 in which a charge inlet 6 is arranged. A power supplying plug 5 can be connected to the charge inlet 6. The charge inlet 6 includes an inlet body 7. A cylindrical power supplying plug fitting unit 8 is arranged at the front of the inlet body 7. The power supplying plug 5 is connected to the power supplying plug fitting unit 8.

The power supplying plug fitting unit 8 includes a plurality of terminal sockets 9 to 13, which receive plug terminals of the power supplying plug 5. The plug terminals include two power line terminals, a ground line terminal, and two signal line terminals. Each of the terminal sockets 9 to 13 are defined by separate cylindrical cavities. In the present example, in correspondence with the plug terminals of the power supplying plug 5, the terminal sockets 9 to 13 include two power line terminal sockets 9 and 10, a ground line terminal socket 11, and two signal line terminal sockets 12 and 13.

A lock module 14 is arranged outward in the radial direction from the charge inlet 6. The lock module 14 is cylindrical, has open ends, and is used to lock the power supplying plug 5. The power supplying plug 5 includes a pivotal lock lever 15 having a distal end that forms a hook 16. A lever catch 17 projects from an upper portion of the lock module 14. When connecting the power supplying plug 5 to the charge inlet 6, the hook 16 of the lock lever 15 is hooked to the lever catch 17. This keeps the power supplying plug 5 connected to the charge inlet 6.

Referring to FIG. 2, a vehicle body connector fitting unit 21 is arranged on a rear surface of the inlet body 7 (in the present embodiment, rear surface of power supplying plug fitting unit 8). A vehicle body connector 18 is connected to the vehicle body connector fitting unit 21. The charge inlet 6 has a direct connection type connector structure that allows the vehicle body connector 18, which extends from a battery (in-vehicle electric device) arranged in the vehicle body 1, to be directly connected to the vehicle body connector fitting unit 21. The vehicle body connector 18 includes a power line female connector 19 and a ground-signal line female connector 20. The vehicle body connector fitting unit 21 includes a first vehicle body connector fitting portion 22, which is connected to the power line female connector 19, and a second vehicle body connector fitting portion 23, which is connected to the ground-signal line female connector 20. The first vehicle body connector fitting portion 22 includes a male connector 24, which is engaged with the female connector 19. The second vehicle body connector fitting portion 23 includes a male connector 25, which is engaged with the female connector 20.

Two power line wire harnesses 26 are connected to the female connector 19. Each power line wire harness 26 is grounded at a middle portion. A ground line wire harness 27 and two signal line wire harnesses 28 are connected to the female connector 20. Each signal line wire harness 28 is connected and grounded at a middle portion to the ground line wire harness 27.

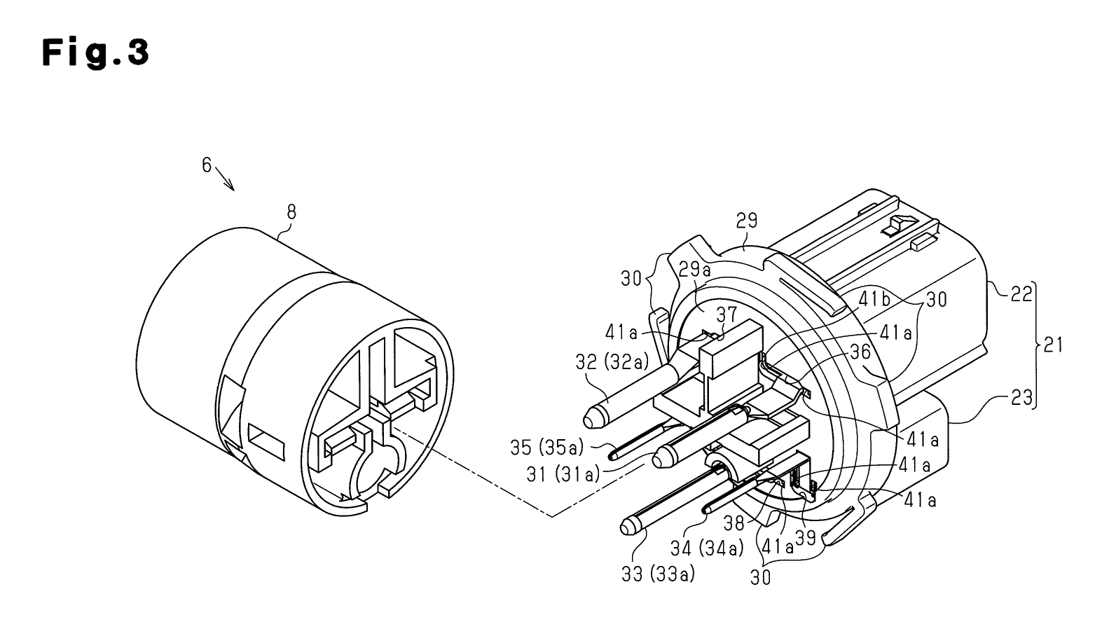

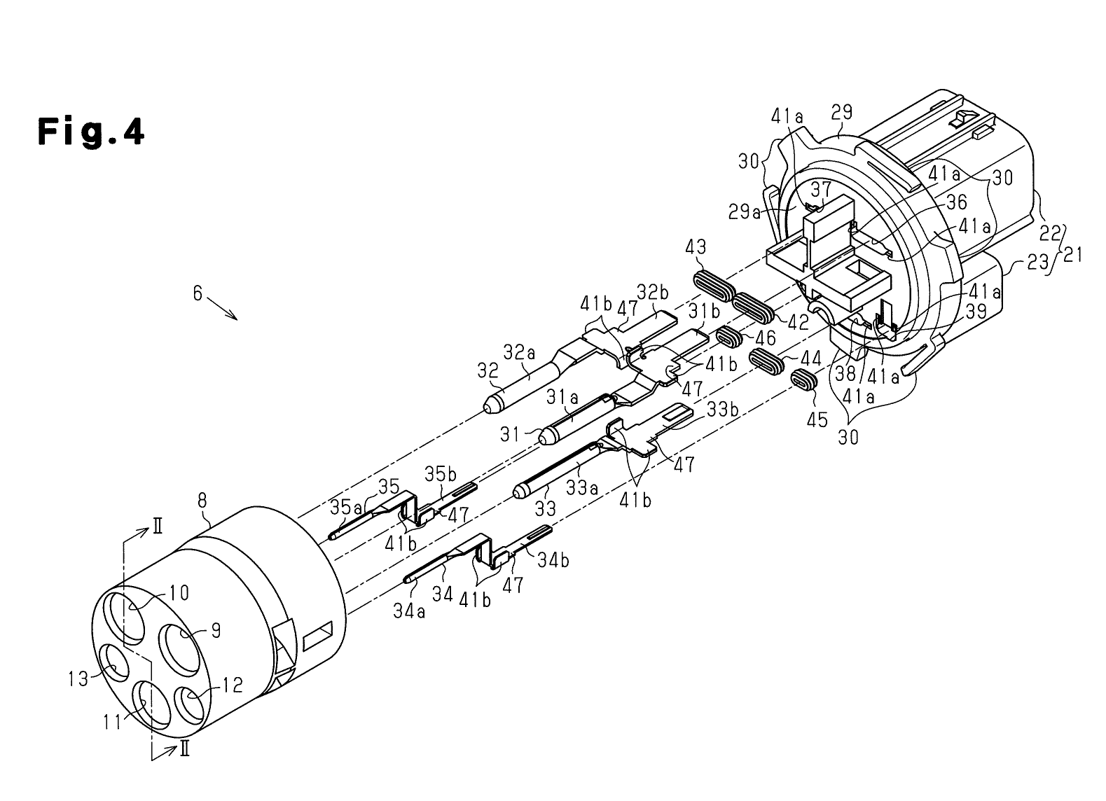

Referring to FIGS. 3 and 4, the inlet body 7 is formed as a single component by integrally coupling the power supplying plug fitting unit 8 and the vehicle body connector fitting unit 21. The vehicle body connector fitting unit 21 includes a flange 29 extending in the circumferential direction around an edge of the power supplying plug fitting unit 8. A plurality of lock module securing portions 30 is formed on the circumference of the flange 29. Each lock module securing portion 30 includes a plate-like projection and an arm-like hook.

Referring to FIGS. 3 to 6, the charge inlet 6 includes a plurality of terminals 31 to 35, which serve as electric terminal members. The terminals 31 to 35 include two power line terminals 31 and 32, a ground line terminal 33, and two signal line terminals 34 and 35. The terminals 31 to 25 include cylindrical distal terminal portions (open side terminal portions) 31a to 35a, which are connected to the power supplying plug 5, and planar basal terminal portions 31b to 35b, which are connected to the vehicle body connector 18.

The flange 29 has a seat surface 29a through which terminal coupling holes 36 to 40 extend. The terminals 31 to 35 can be inserted into and coupled to the terminal coupling holes 36 to 40. Two press-fit pieces 41b are formed on each of the terminals 31 to 35 at two sides opposing each other in the direction orthogonal to the longitudinal direction of the terminals 31 to 35. The terminals 31 to 35 are fixed to the seat surface 29a by press-fitting the two press-fit pieces 41b into two narrow holding portions 41a formed at opposite sides of the corresponding terminal coupling holes 36 to 40.

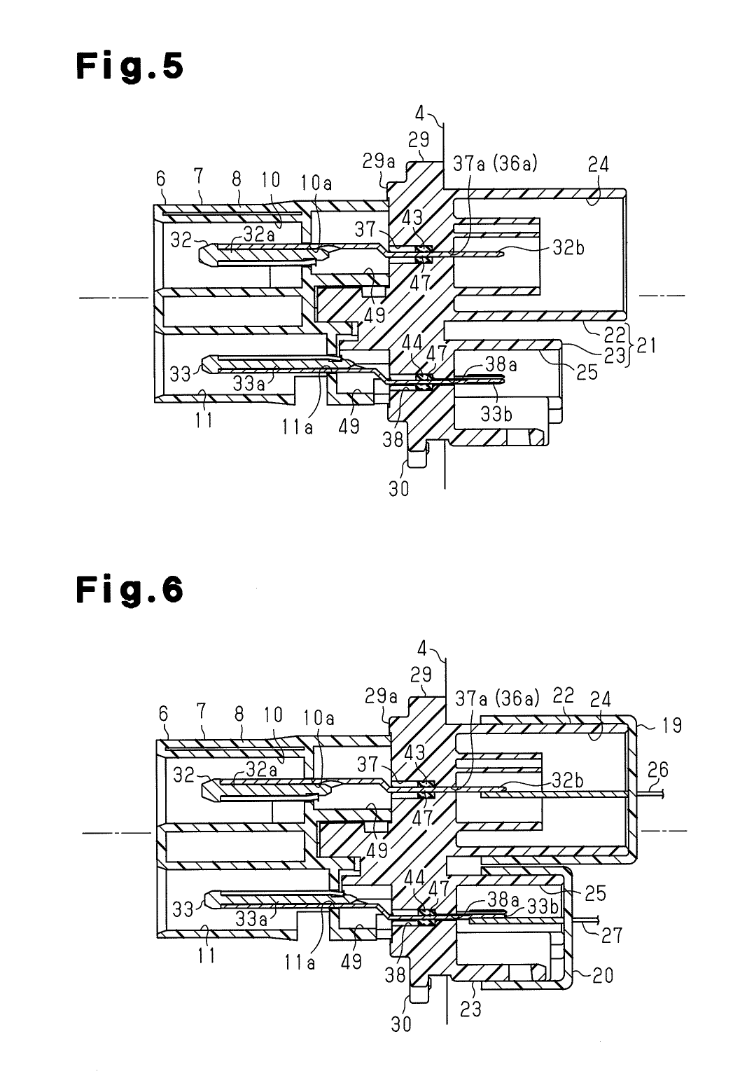

Referring to FIGS. 5 and 6, the distal terminal portions 31a to 35a are inserted through insertion sockets 9a to 13a, which extend through bottom walls of the terminal sockets 9 to 13, and exposed in the terminal sockets 9 to 13. The basal terminal portions 31b to 35b are inserted through small holes 36a to 40a, which extend further from the terminal coupling holes 36 to 40, and are exposed in the male connectors 24 and 25. As shown in FIG. 1, when the charge inlet 6 is coupled to the vehicle body 1, the power supplying plug fitting unit 8 is exposed from the power supplying port 3, and the vehicle body connector fitting unit 21 is located at the inner side of the vehicle body 1.

Referring to FIGS. 4 to 8, ring seals 42 to 46 are arranged on the terminals 31 to 35 to protect the vehicle body connector fitting unit 21 from water. Each of the seals 42 to 46 is formed by, for example, a resin (rubber) packing. The press-fitting of the terminals 31 to 35 (press-fit pieces 41b) position and fix the seals 42 to 46 to the terminal coupling holes 36 to 40.

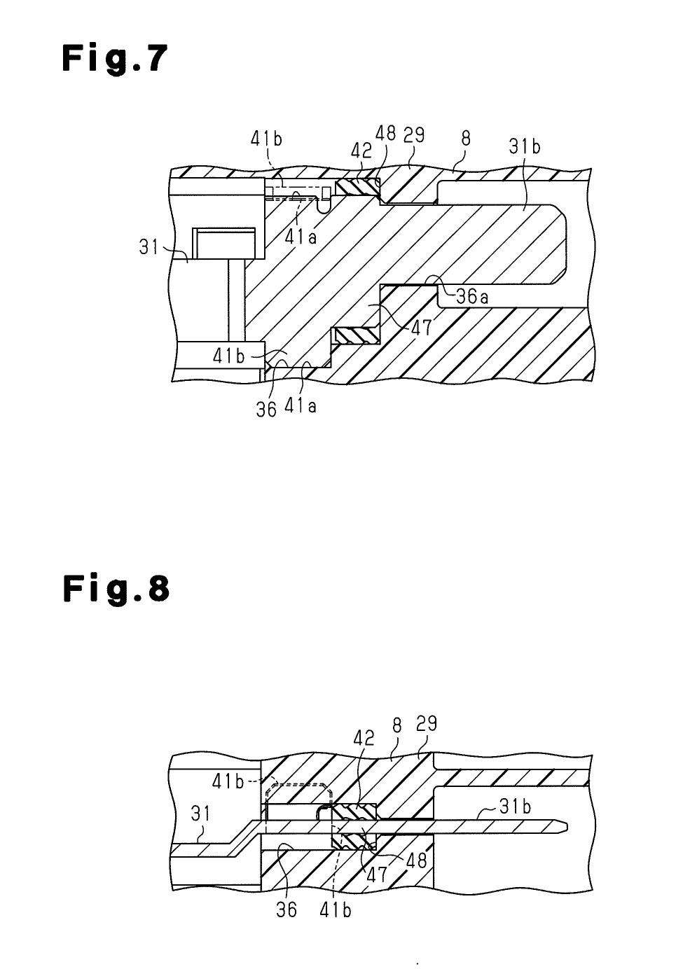

Further, as shown in FIGS. 4 to 8, the seals 42 to 46 are coupled to seal coupling portions 47, which are located at middle parts of the basal terminal portions 31b to 35b, and arranged toward the inner ends of the terminal coupling holes 36 to 40. The press-fit pieces 41b and steps 48 (refer to FIGS. 7 and 8), which are formed at the inner ends of the terminal coupling holes 36 to 40, hold the seals 42 to 46 from opposite sides.

The task for connecting wires of the charge inlet 6, which has a direct connection type connector structure, will now be described with reference to FIGS. 6 to 8.

Referring to FIG. 6, the charge inlet 6 is first coupled to the vehicle body 1. Then, the power line female connector 19, which includes distal ends of the power line wire harnesses 26 extending from the battery (in-vehicle electric device), is connected to the first vehicle body connector fitting portion 22. Further, the ground-signal line female connector 20, which includes distal ends of the ground line wire harness 27 extending from the battery (in-vehicle electric device), and the two signal line wire harnesses 28 are connected to the second vehicle body connector fitting portion 23. Thus, the female connectors 19 and 20 are merely connected to the charge inlet 6 to electrically connect the charge inlet 6 and the in-vehicle electric device.

Further, the seals 42 to 46 impede water from entering gaps between the terminals 31 to 35 and the walls of the terminal coupling holes 36 to 40 (in FIGS. 7 and 8, the terminal 31, terminal coupling hole 36, and seal 42 are illustrated). Thus, even when water enters a clearance between the terminals 31 to 35 and the walls of the insertion sockets 9a to 13a and reaches a void 49, the seals 42 to 46 effectively impede the water from proceeding further. This protects the vehicle body connector fitting unit 21 from water. Further, the terminals 31 to 35 are securely fixed to the terminal coupling holes 36 to 40 by the press-fit pieces 41b. This also securely fixes the seals to the terminal coupling holes 36 to 40.

The present embodiment has the advantages described below.

(1) The vehicle body connector fitting unit 21 is formed in the rear surface of the charge inlet 6. Accordingly, the charge inlet 6 integrally includes the power supplying plug fitting unit 8 and the vehicle body connector fitting unit 21. In other words, the charge inlet 6 has a direct connection type connector structure that allows for direct connection to a wire harness that extends from an in-vehicle electric device. This eliminates the need for a complicated wire harness structure in the charge inlet 6. Thus, the wire connection structure of the charge inlet 6 can be simplified.

(2) The connection of the power line female connector 19 and ground-signal line female connector 20 to the charge inlet 6 completes the connection of wire harnesses. This facilitates the task for connecting the wire harnesses.

(3) The number of wire harnesses can be reduced. This simplifies the task for coupling the charge inlet 6. Accordingly, the charge inlet 6 has a high cost reduction effect.

(4) The seals 42 to 46 are coupled to the terminals 31 to 35. Thus, water entering the power supplying plug fitting unit 8 may be prevented from reaching the male connectors 24 and 25. This increases the water resistant effect of the vehicle body connector fitting unit 21.

(5) In a state in which the seals 42 to 46 are held between the press-fit pieces 41b of the terminals 31 to 35 and the steps 48 of the terminal coupling holes 36 to 40, the terminals 31 to 35 are press-fitted and fixed to the terminal coupling holes 36 to 40. This also fixes the seals 42 to 46 to the terminal coupling holes 36 to 40. In this manner, when the terminals 31 to 35 are fastened, the seals 42 to 46 are also securely fixed to the terminal coupling holes 36 to 40.

It should be apparent to those skilled in the art that the present invention may be embodied in many other specific forms without departing from the spirit or scope of the invention. Particularly, it should be understood that the present invention may be embodied in the following forms.

The seals 42 to 46 do not have to be positioned and fixed to the terminal coupling holes 36 to 40 by press-fitting and fixing the terminals 31 to 35 to the terminal coupling holes 36 to 40. For example, grooves may be formed in the walls of the terminal coupling holes 36 to 40, and the seals 42 to 46 may be fitted to the grooves.

Seals are not limited to the ring seals 42 to 46 coupled to the terminals 31 to 35. That is, any member can be used instead of the seals 42 to 46 as long as the gaps between the terminals 31 to 35 and the walls of the terminal coupling holes 36 to 40 can be filled.

The panel 4 may include an indicator, which indicates the state of charge, or various switches.

The terminals 31 to 35 are not limited to the shapes of the above embodiment and may be changed to any shape.

In the above embodiment, the terminals 31 to 35 are extended over the power supplying plug fitting unit 8 and the vehicle body connector fitting unit 21, exposed from the power supplying plug fitting unit 8, and exposed from the vehicle body connector fitting unit 21. This allows for a terminal, which serves as a terminal member, to be formed by a single component. Thus, the number of components can be reduced. However, instead of exposing one end of each of the terminals 31 to 35 from the power supplying plug fitting unit 8, dedicated terminals connected by wires to the ends of the terminals 31 to 35 may be arranged in the vehicle body connector fitting unit 21.

The terminals 31 to 35 do not have to be press-fitted to be fixed to the terminal coupling holes 36 to 40. The terminals 31 to 35 may be fixed through other means, for example, by performing swaging or by using an adhesive.

The terminal coupling holes 36 to 40 do not have to include small holes 36a to 40a and may be holes having uniform dimensions.

The vehicle body connector fitting unit 21 does not have to be formed by two vehicle body connector fitting portions and may be formed from, for example, just one fitting portion or three or more fitting portions.

The vehicle body connector fitting unit 21 does not have to be formed on the rear surface of the power supplying plug fitting unit 8 and may be formed at other locations.

The number of terminals in the charge inlet 6 is not limited to five, and the charge inlet 6 may include any number of terminals.

The terminals in the charge inlet 6 do not have to be arranged in the circumferential direction, and the layout of the terminals may be changed in any manner.

The battery does not have to be used to supply power that drives a vehicle and may be a rechargeable battery or a power storage device installed in a vehicle.

The charge inlet 6 does not have to include the separate terminal sockets 9 to 13 respectively provided for the terminals 31 to 35. For example, the terminals 31 to 35 may all be arranged in a single large terminal socket.

The vehicle is not limited to a plug-in hybrid vehicle or electric vehicle and may be any vehicle that requires charging of an in-vehicle battery or power storage device.

The present examples and embodiments are to be considered as illustrative and not restrictive, and the invention is not to be limited to the details given herein, but may be modified within the scope and equivalence of the appended claims.

1. A charge inlet connectable to a power supplying plug that charges a vehicle battery, the charge inlet comprising:
a power supplying plug fitting unit connectable to the power supplying plug; and
a vehicle body connector fitting unit arranged integrally with the power supplying plug fitting unit and connected to a vehicle body connector extending from the battery,
wherein the charge inlet includes a direct connection type connector that allows for direct connection of the vehicle body connector to the vehicle body connector fitting unit.

2. The charge inlet according to claim 1, wherein the vehicle body connector fitting unit is formed on a rear surface of the power supplying plug fitting unit and is connectable to a power line, a ground line, and a signal line.

3. The charge inlet according to claim 1, wherein the vehicle body connector fitting unit includes:
a first vehicle body connector fitting portion connectable to a power line, and
a second vehicle body connector fitting portion connectable to a ground line and a signal line.

4. The charge inlet according to claim 1, further comprising a seal arranged between the power supplying plug fitting unit and the vehicle body connector fitting unit to prevent water from entering the vehicle body connector fitting unit from the power supplying plug fitting unit.

5. The charge inlet according to claim 1, further comprising a terminal member extending over the power supplying plug fitting unit and the vehicle body connector fitting unit, wherein the terminal member includes one end exposed from the power supplying plug fitting unit and another end exposed from the vehicle body connector fitting unit.

6. The charge inlet according to claim 5, wherein
the seal is coupled to the terminal member, and
the terminal member is press-fitted and fixed to the vehicle body connector fitting unit to position and fix the seal to the vehicle body connector fitting unit.

7. A charge inlet comprising:
a power supplying plug fitting unit, arranged on a first distal portion of the charge inlet, operative to engage a power supply plug and maintain an electrical connection with the power supply plug;
a vehicle body connector fitting unit, arranged on a second distal portion of the charge inlet, comprising a mechanical engagement portion and an electrical terminal portion, the vehicle body connector fitting unit operative to mechanically engage a connector of a wire harness and align the electrical terminal portion of the vehicle body connector fitting unit with a terminal of the wire harness that is electrically connected to an in-vehicle electric device.

8. The charge inlet according to claim 7, further comprising a seal arranged between the power supplying plug fitting unit and the vehicle body connector fitting unit, wherein the seal substantially impedes water from entering the vehicle body connector fitting unit via the power supplying plug fitting unit.
